(19) United States
(12) Patent Application Publication
(10) Pub. No.: US 2026/0161959 A1
(43) Pub. Date: Jun. 11, 2026

(54) MULTI-MODAL DIFFUSION MODELS

(71) Applicant: QUALCOMM Incorporated, San Diego, CA (US)

(72) Inventors: Adil KARJAUV, Diemen (NL); Amir GHODRATI, Amsterdam (NL); Amirhossein HABIBIAN, Amsterdam (NL)

(21) Appl. No.: 18/974,441

(22) Filed: Dec. 9, 2024

(51) Int. Cl. G06N 3/0985

(52) U.S. Cl. CPC G06N 3/0985

(57) ABSTRACT

Systems and techniques are described herein for generating data. For instance, a method may include processing, using a diffusion model at a stage of an iterative diffusion process based on a first condition, output data from a prior stage of the iterative diffusion process to generate first output data; processing, using the diffusion model at the stage of the iterative diffusion process based on a second condition, the output data from the prior stage of the iterative diffusion process to generate second output data; scaling the first output data based on a first scaling factor to generate first scaled output data, wherein the first scaling factor is based on the first condition and the stage; scaling the second output data based on a second scaling factor to generate second scaled output data, wherein the second scaling factor is based on the second condition and the stage.

### TECHNICAL FIELD

The present disclosure generally relates to diffusion models. For example, aspects of the present disclosure include systems and techniques for multi-modal diffusion models.

### BACKGROUND

Diffusion models include a family of algorithms for generative modelling that achieve high-quality performance in several tasks (e.g., generating images based on text). Some diffusion-model algorithms are capable of using multiple modes of input (e.g., text and an image). For example, a diffusion models for editing images may be capable of editing in input image based on text instructions.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating data. According to at least one example, a method is provided for generating data. The method includes: processing, using a diffusion model at a stage of an iterative diffusion process based on a first condition, output data from a prior stage of the iterative diffusion process to generate first output data; processing, using the diffusion model at the stage of the iterative diffusion process based on a second condition, the output data from the prior stage of the iterative diffusion process to generate second output data; scaling the first output data based on a first scaling factor to generate first scaled output data, wherein the first scaling factor is based on the first condition and the stage; scaling the second output data based on a second scaling factor to generate second scaled output data, wherein the second scaling factor is based on the second condition and the stage; and combining the first scaled output data and the second scaled output data to generate output data of the stage of the iterative diffusion process.

In another example, an apparatus for generating data is provided that includes at least one memory and at least one processor (e.g., configured in circuitry) coupled to the at least one memory. The at least one processor configured to: process, using a diffusion model at a stage of an iterative diffusion process based on a first condition, output data from a prior stage of the iterative diffusion process to generate first output data; process, using the diffusion model at the stage of the iterative diffusion process based on a second condition, the output data from the prior stage of the iterative diffusion process to generate second output data; scale the first output data based on a first scaling factor to generate first scaled output data, wherein the first scaling factor is based on the first condition and the stage; scale the second output data based on a second scaling factor to generate second scaled output data, wherein the second scaling factor is based on the second condition and the stage; and combine the first scaled output data and the second scaled output data to generate output data of the stage of the iterative diffusion process.

In another example, a non-transitory computer-readable medium is provided that has stored thereon instructions that, when executed by one or more processors, cause the one or more processors to: process, using a diffusion model at a stage of an iterative diffusion process based on a first condition, output data from a prior stage of the iterative diffusion process to generate first output data; process, using the diffusion model at the stage of the iterative diffusion process based on a second condition, the output data from the prior stage of the iterative diffusion process to generate second output data; scale the first output data based on a first scaling factor to generate first scaled output data, wherein the first scaling factor is based on the first condition and the stage; scale the second output data based on a second scaling factor to generate second scaled output data, wherein the second scaling factor is based on the second condition and the stage; and combine the first scaled output data and the second scaled output data to generate output data of the stage of the iterative diffusion process.

In another example, an apparatus for generating data is provided. The apparatus includes: means for processing, using a diffusion model at a stage of an iterative diffusion process based on a first condition, output data from a prior stage of the iterative diffusion process to generate first output data; means for processing, using the diffusion model at the stage of the iterative diffusion process based on a second condition, the output data from the prior stage of the iterative diffusion process to generate second output data; means for scaling the first output data based on a first scaling factor to generate first scaled output data, wherein the first scaling factor is based on the first condition and the stage; means for scaling the second output data based on a second scaling factor to generate second scaled output data, wherein the second scaling factor is based on the second condition and the stage; and means for combining the first scaled output data and the second scaled output data to generate output data of the stage of the iterative diffusion process.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for implementing an iterative, classifier-free, diffusion process, according to various aspects of the present disclosure;

FIG. 2 includes two sets of images that show the forward diffusion process (which is fixed) and the reverse diffusion process (which is learned) of a diffusion model, according to various aspects of the present disclosure;

FIG. 3 includes a diagram illustrating how diffusion data is distributed from initial data to noise using a diffusion model in the forward diffusion direction, according to various aspects of the present disclosure;

FIG. 4 is a diagram illustrating a U-Net architecture for a diffusion model, according to various aspects of the present disclosure;

FIG. 5 is a block diagram illustrating an example stage of an iterative, classifier-free, diffusion process, according to various aspects of the present disclosure;

FIG. 6 is a flow diagram illustrating an example process for generating data, in accordance with aspects of the present disclosure;

FIG. 7 is a block diagram illustrating an example of a deep learning neural network that can be used to perform various tasks, according to some aspects of the disclosed technology;

FIG. 8 is a block diagram of an example transformer in accordance with some aspects of the disclosure, according to various aspects of the present disclosure; and

FIG. 9 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, diffusion models include a family of algorithms for generative modelling that achieve high-quality performance in several tasks (e.g., generating images, audio, video etc. based on text, images, video, audio, etc.). Some diffusion-model algorithms are capable of using multiple modes of input (e.g., text and an image). For example, a diffusion models for editing images may be capable of editing in input image based on text instructions.

Diffusion models generally use one input and may use multiple input conditionings. Classifier-free guidance is a technique for managing multiple input conditionings (including multi-modal input conditionings). Classifier-free guidance may include performing several inference runs and combining (e.g., linearly) outputs of the inference runs to generate an output. Classifier-free guidance may manage trade-offs between quality and fidelity when managing the use of input conditionings. Conventionally, during inference, hyperparameters controlling a Classifier-free guidance (“guidance scales”) are kept constant across different sampling steps limiting a diffusion model's generation capabilities.

In general, conditional diffusion models (e.g., diffusion models that process input data based on input conditionings) are learned by minimizing ∇ₓ log p(x|y)—a score function that determines the direction that maximizes the likelihood of the distribution of the data x conditioned on y.

Additionally conditional diffusion models may operate according to Bayes' rule:

$$p ( x \vert y ) = \frac{p ( y \vert x ) \cdot p ( x )}{p ( y )} :$$

$${∇}_{x} log p ( x \vert y ) = {∇}_{x} ( log p ( y \vert x ) + log p ( x ) - log p ( y ) )$$

$${∇}_{x} log p ( x \vert y ) = {∇}_{x} ( log p ( y \vert x ) + {∇}_{x} log p ( x )$$

A scalar γ (e.g., a guidance scale) is used to amplify the guidance of the conditioning term in generation:

$${∇}_{x} log {p}_{γ} ( x \vert y ) = {∇}_{x} log p ( x ) + γ {∇}_{x} log p ( y \vert x )$$

Classifier guidance may involve estimating p(y|x) using a conditioning prediction model, (e.g., an image classifier if y is image-classes). Additionally, classifier guidance may require training the classifier with the score function—as a pretrained classifier is not robust to the noise.

In contrast, classifier-free guidance does not require training a separate classifier. Instead, classifier-free guidance trains a conditional diffusion model p(x|y) with conditioning dropout. For example, some percentage of the time, the conditioning information y is dropped from the input. The model trained by conditioning dropout is then able to model both a conditional distribution p(x|y) and unconditional one p(x).

Classifier-free Guidance may operate according to:

$${∇}_{x} log {p}_{γ} ( x \vert y ) = {∇}_{x} log p ( x ) + γ {∇}_{x} log p ( y \vert x )$$

$${∇}_{x} log {p}_{γ} ( x \vert y ) = {∇}_{x} log p ( x ) + γ ( {∇}_{x} log p ( y \vert x ) - {∇}_{x} log p ( x ) ) [ Bayes ' rule ]$$

$${∇}_{x} log {p}_{γ} ( x \vert y ) = ( 1 - γ ) {∇}_{x} log p ( x ) + γ {∇}_{x} log p ( x \vert y )$$

The guidance scales (γ>1) are hyper-parameters kept fixed during the sampling steps.

Systems, apparatuses, methods (also referred to as processes), and computer-readable media (collectively referred to herein as “systems and techniques”) are described herein for multi-modal diffusion models. For example, the systems and techniques described herein may use different guidance scale values across different sampling steps for each of the conditionings to better control generation of output data.

For instance, for image-editing-based diffusion models, in early sampling steps guidance scales are set so that the iterative denoising process relies more on the conditioned image rather than text (to facilitate the fidelity to the source image). In later sampling steps the guidance scales are set to focus on conditioning inputs to focus on the editing.

By introducing a new dimension (sampling steps) to guidance scale values, the systems and techniques enhance variability and control of the generative process. Thus, the systems and techniques improve the generative capacity of diffusion models.

For example, the systems and techniques may be used to improve image-editing diffusion models and/or video-editing diffusion models that use images, text, poses, edges, etc. as conditioning inputs. As another example, the systems and techniques may improve novel-view synthesis and three-dimensional (3D) reconstruction tasks. As yet another example, the systems and techniques may improve tasks that edit 3D scenes based on text instructions.

Various aspects of the application will be described with respect to the figures below.

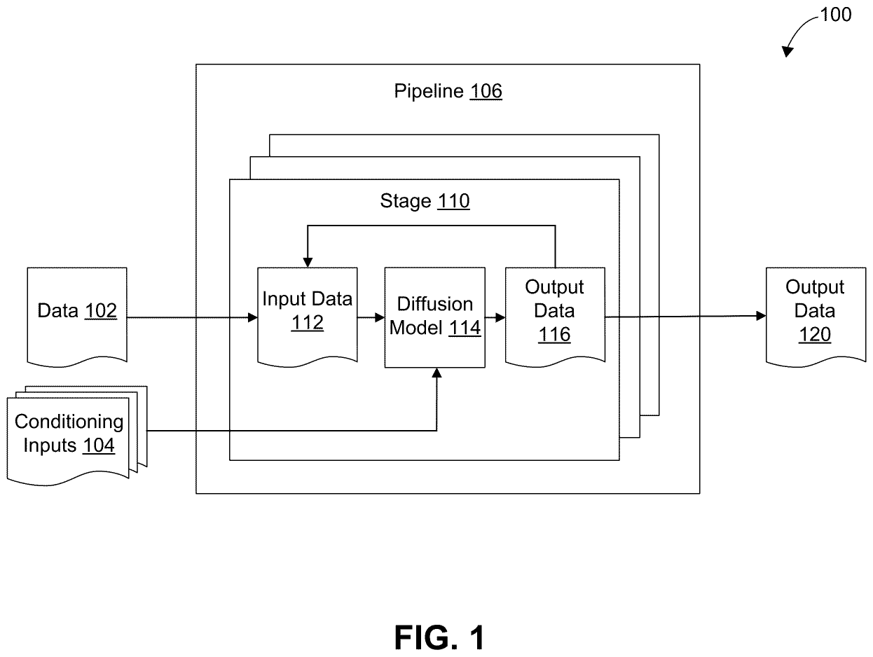

FIG. 1 is a block diagram illustrating an example system 100 for implementing an iterative, classifier-free, diffusion process, according to various aspects of the present disclosure. In general, pipeline 106 may receive data 102 and conditioning inputs 104. Pipeline 106 may include a number of stages 110. At a first stage 110, pipeline 106 may use data 102 as input data 112. At each of stage 110, pipeline 106 may process input data 112 (based on conditioning inputs 104) using a diffusion model 114 to generate output data 116. After the first stage 110, pipeline 106 may use output data 116 of a prior stage 110 as input data 112 to each subsequent stage 110. A final stage 110 may output its output data 116 as output data 120.

Data 102 may be, or may include, image data any type or mode of data including, as examples, video data, audio data, and numerical data. In some aspects, data 102 may be random data, such as Gaussian noise.

Conditioning inputs 104 may be, or may include, any time or mode of data including, as examples, video data, audio data, and numerical data. Conditioning inputs 104 may include multi-modal data, including two separate modes of data.

Input data 112 and output data 116 represent intermediate data in the process of generating output data 120 based on data 102. Input data 112 and output data 116 may be of the same type or mode as data 102. Input data 112 and output data 116 may, depending on where they are in the process of being generated, be more like data 102 or more like output data 120.

Pipeline 106 may implement a reverse-diffusion process through stage 110 to generate output data 120 based on data 102 and conditioning inputs 104. Output data 120 may be, or may include, any time or mode of data including, as examples, video data, audio data, and numerical data.

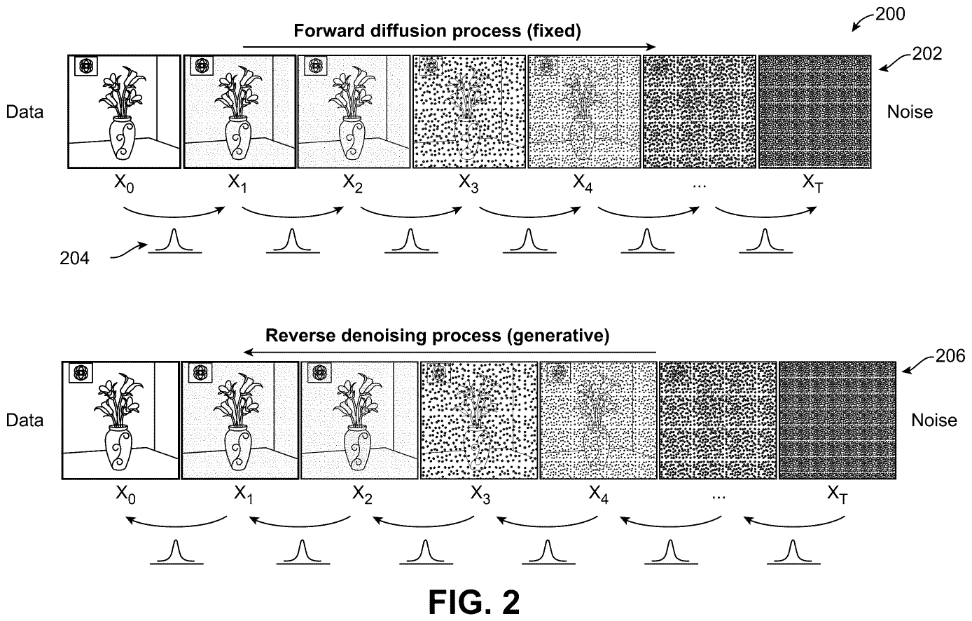

FIG. 2 provides two sets of images 200 that show the forward diffusion process (which is fixed) and the reverse diffusion process (which is learned) of a diffusion model. As shown in the forward diffusion process of FIG. 2, noise 204 is gradually added to a first set of images 202 at different time steps for a total of T time steps (e.g., making up a Markov chain), producing a sequence of noisy samples X₁ through X_{T}.

Diffusion models from a training perspective will take an image and will slowly add noise to the image to obscure the information in the image. In some aspects, the noise 204 is Gaussian noise. Each time step can correspond to each consecutive image of the first set of images 202 shown in FIG. 2. The initial image X₀ of FIG. 2 is of a vase of flowers. Addition of the noise 204 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian [symbol] (0, 1).

The second set of images 206 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 2, the reverse diffusion process proceeds to generate X₀ as the image of the vase of flowers. In other cases, the input data and output data can vary based on the task for which the diffusion model is trained.

As noted above, the diffusion model is trained to be able to denoise or recover the original image X₀ in an incremental process as shown in the second set of images 206. In some aspects, the neural network of the diffusion model can be trained to recover Xₜ given Xₜ₋₁, such as provided in the below example equation:

$$q ( {x}_{t} \vert {x}_{t - 1} ) = ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ ( 0 , I ) .$$

In some cases, the βₜ values schedule (also referred to as a noise schedule) is designed such that \hat{∝}_{T}→0 and q(x_{T}|x₀)≈ [symbol] (x_{T}; 0, I).

The diffusion model runs in an iterative manner to incrementally generate the input image X₀. In one example, the model may have twenty steps. However, in other examples, the number of steps can vary.

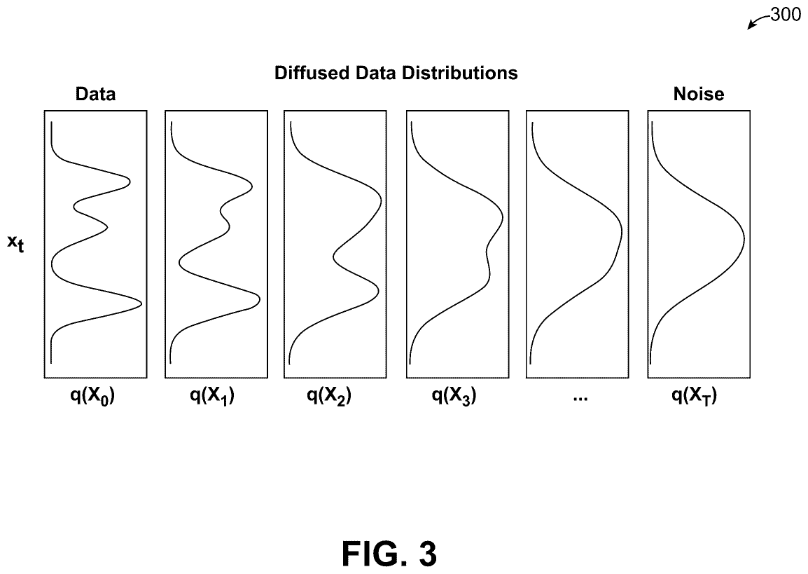

FIG. 3 is a diagram 300 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the flowers in a vase shown in FIG. 2. As the diffusion model iterates and iteratively adds sampled noise to the data from t=0 to t=T, as shown in FIG. 3, the data becomes nosier and may ultimately result in pure noise (e.g., at q(X_{T})). The example of FIG. 3 illustrates the progression of the data and how it becomes diffused with noise in the forward diffusion process.

In some aspects, the diffused data distribution (e.g., as shown in FIG. 3) can be as follows:

$$q ( {x}_{t} ) = \int q ( {x}_{0} , {x}_{t} ) d {x}_{0} = \int q ( {x}_{0} ) q ( {x}_{t} \vert {x}_{0} ) d {x}_{0} .$$

In the above equation, q(xₜ) represents the diffused data distribution, q(x₀, xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

1: repeat
2: x₀ ~ q(x₀)
3: t ~ Uniform ({1, . . . , T })
4: ∈ ~ [symbol] (0, I)
5: Take gradient descent step on
${∇}_{∅} {‖ ∈ - {∈}_{∅} ( \sqrt{{\hat{∝}}_{t} {x}_{0}} + \sqrt{1 - {\hat{∝}}_{t}} ∈ , t ) ‖}^{2}$
6: until converged

A sampling algorithm can include the following steps:

1: x_{T} ~ [symbol] (0, I)
2: for t = T, . . . , 1 do
3: z ~ [symbol] (0, I)
$4 \text{:} {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{∅} ( {x}_{t} , t ) ) + {σ}_{t} z$
5: end for
6: return x₀

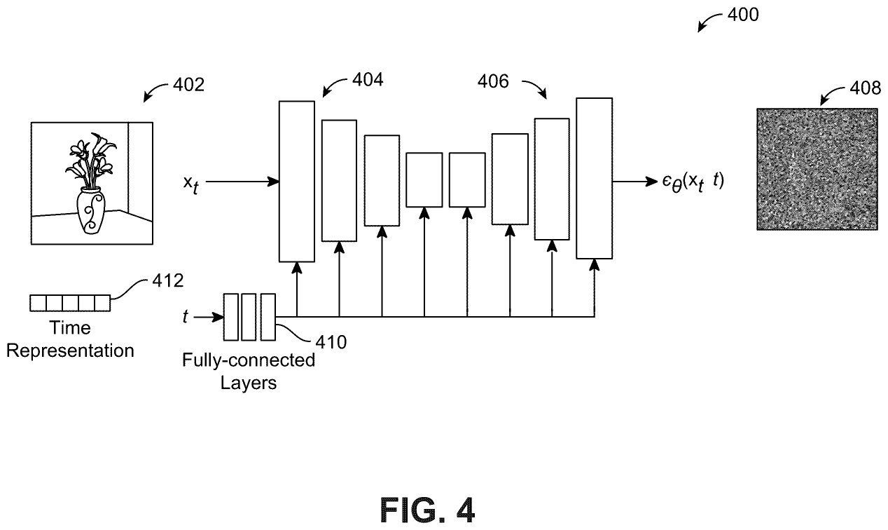

FIG. 4 is a diagram illustrating a U-Net architecture 400 for a diffusion model, in accordance with some aspects. The initial image 402 (e.g., a vase of flowers) is provided to the U-Net architecture 400 which includes a series of residual networks (ResNet) blocks and self-attention layers to represent the network ϵ_{θ}(xₜ, t). The U-Net architecture 400 also includes fully-connected layers 410. In some cases, time representation 412 can be sinusoidal positional embeddings or random Fourier features. Noisy output 408 from the forward diffusion process is also shown.

The U-Net architecture 400 includes a contracting path 404 and an expanding path 406 as shown in FIG. 4, which gives it the U-shaped architecture. The contracting path 404 can be a convolutional network that includes repeated convolutional layers (that apply convolutional operations), each followed by a rectified linear unit (ReLU) and a max pooling operation. When images are being processed (e.g., the image 402) during the contracting path 404, the spatial information of the image 402 is reduced as features are generated. The expanding path 406 combines the features and spatial information through a sequence of up-convolutions and concatenations with high-resolution features from the contracting path 404. Some of the layers can be self-attention layers, which leverage global interactions between semantic features at the end of the encoder to explicitly model full contextual information.

Latent diffusion models (also referred to as stable diffusion models) introduce a diffusion process in the latent space of a machine learning model (e.g., variational autoencoder (VAE) neural network), making the machine learning model more efficient while enabling high-resolution image synthesis. For example, an Encoder (ε)-Decoder (D) pair of a VAE can be trained to capture a low-dimensional latent distribution given by z=ε(x) such that x≈D(z). The denoising process outlined above can be formulated in the latent space by training a U-Net (e.g., U-Net architecture 400 of FIG. 4), which may include ResNet blocks and attention modules in some cases, to predict the noise introduced in the forward diffusion process, which optimizes the objective given by the following:

$${min}_{θ} {z 0 , ϵ ∼ N ( 0 , 1 ) , t ∼ U ( 0 , T )}_{} {‖ ϵ - {ϵ}_{θ} ( {z}_{t} , t , c ) ‖}_{2}^{2}$$

Here, E is the total noise introduced to the noise-free latent z₀˜E(x) by the scheduler in T steps, zₜ is the corresponding partially-noisy latent at diffusion timestep t, and c is conditioning (e.g., text prompt embedding provided as input). With the predicted noise ϵ_{θ}, denoising diffusion implicit models (DDIM) sampling can be applied on z_{T} over T steps iteratively to recover z₀ in the original latent data distribution, such as in the following:

$${z}_{t - 1} = \sqrt{{α}_{t - 1}} \frac{{z}_{t} - \sqrt{1 - {α}_{t} {ϵ}_{θ}}}{\sqrt{{α}_{t}}} + \sqrt{1 - {α}_{t} {ϵ}_{θ}} ,$$

where αₜ is a parameter for noise scheduler.

When adopting Stable Diffusion (SD) to video generation or video editing, a key factor is to ensure the temporal consistency of a generated frame relative to one or more previous frames in the video. In addition to modifications to the U-Net model (such as temporal attention and 2+1D convolutions), it helps to rely on control signals, and/or DDIM inversion to start the denoising with a correlated set of noise latents.

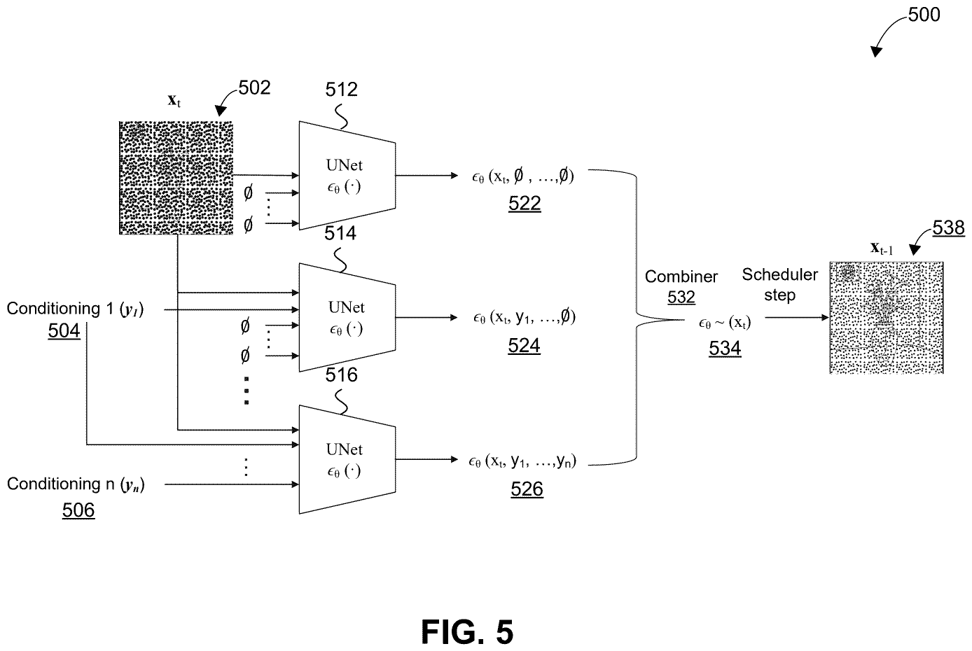

FIG. 5 is a block diagram illustrating an example stage 500 of an iterative, classifier-free, diffusion process, according to various aspects of the present disclosure. Stage 500 represents one stage, for example, stage 110 of FIG. 1, or from x₄ to x₃ or from x₃ to x₂ of the reverse denoising process of FIG. 2.

In general, stage 500 may process input data 502 to generate output data 534. A prior stage of the iterative process may generate input data 502 (e.g., in the same what the stage 500 generates output data 534). A subsequent stage of the iterative process may use output data 534 as an input to generate output data (e.g., in the same what the stage 500 uses input data 502 as input). For example, input data 502 may be an example of input data 112 and output data 534 may be an example of output data 116.

Input data 502 may be data processed by stage 500. Input data 502 may be, or may become, image data, a frame of video data, audio data, etc. Input data 502 represents data at a stage 500 (e.g., stage t) in the process of being generated. Input data 502 is alternatively referred to as xₜ.

Conditioning input 504 and conditioning input 506 represent two of any number (e.g., n) of conditioning inputs. Conditioning input 504 represents a first conditioning input y₁ and conditioning input 506 represents an nth conditioning input yₙ. Conditioning input 504 and conditioning input 506 (and other conditioning inputs not illustrated in FIG. 5) may be any type (or mode) of data. For example, conditioning input 504 and conditioning input 506 may be, or may include, image data, text, audio data, video data, numerical data, etc.

Unlike input data 502, conditioning input 504 and conditioning input 506 may remain constant from stage to stage. For example, a user may provide a diffusion-model with an input image of subject, a text instruction (e.g., to modify the input image), and an audio clip. Input data 502 represents the input image in various stages of the iterative process of modifying the input image. Conditioning input 504 may represents the instruction text, and conditioning input 506 may represent the audio clip. The instruct text and the audio clip may remain constant and be applied at each stage of the iterative process of generating input data 502.

Diffusion model 512, diffusion model 514, and diffusion model 516 represent three diffusions models of any number (e.g., n) diffusion models that may be used to process input data 502 based on conditioning input 504 and conditioning input 506. In some aspects, diffusion model 514, diffusion model 514, and diffusion model 516 may be, or may include, separate diffusion models that may run in parallel. In other aspects, diffusion model 512, diffusion model 514, and diffusion model 516 may be, or may include, the same diffusion model provided with different inputs at different times.

Each of diffusion model 512, diffusion model 514, and diffusion model 516 may be, or may include, a U-net architecture, for example as illustrated and described with regard to architecture 400 of FIG. 4. The operation of each of diffusion model 512, diffusion model 514, and diffusion model 516 may be denoted Co.

Diffusion model 512 may process input data 502 to generate output data 522. Diffusion model 512 may generate output data 522 without using any conditioning inputs. Output data 522 may be denoted ϵ_{θ}(xₜ, Ø, . . . , Ø), indicating the operation of diffusion model 512 on input data 502 without any additional conditioning inputs.

Diffusion model 514 may process input data 502 based on conditioning input 504 to generate output data 524. Output data 524 may be denoted ϵ_{θ}(xₜ, y₁ . . . , Ø), indicating the operation of diffusion model 514 on input data 502 using conditioning input 504 as a conditioning input.

Diffusion model 516 may process input data 502 based on conditioning input 504 and conditioning input 506 to generate output data 526. Output data 526 may be denoted ϵ_{θ}(xₜ, y₁, . . . , yₙ), indicating the operation of diffusion model 516 on input data 502 using conditioning input 504 and conditioning input 506 as conditioning inputs.

Combiner 532 may combine output data 522, output data 524, output data 526 (and any additional outputs from any additional diffusion models based on any additional conditioning inputs not illustrated in FIG. 5) to generate output data 534. Output data 534 may be denoted ϵ_{θ}^{˜}(xₜ). ϵ_{θ}^{˜}(xₜ) may be an estimated noise at the current timestep.

A scheduler may takes ϵ_{θ}^{˜}(xₜ) as an input and produces xₜ₋₁. xₜ₋₁ is a next timestep latent 538 in the diffusion process. FIG. 5 includes a illustrative depiction of timestep latent 538 as noisy image data, as an example.

When combining outputs of diffusion models (e.g., at combiner 532), some classifier-free diffusion pipelines may weight outputs of diffusion models (e.g., output data 522, output data 524, and output data 526) based on the conditioning inputs used to generate the outputs. For example, such pipelines may apply guidance scales, denoted as γ, to outputs based on the conditioning inputs used to generate the outputs. For example, such pipelines may combine outputs according to:

$$\begin{matrix}{ϵ}_{θ}^{\sim} ( {x}_{t} ) = {ϵ}_{θ} ( {x}_{t} , ∅ , … , ∅ ) + … \\ {γ}^{1} ( {ϵ}_{θ} ( {x}_{t} , {y}_{1} , … , ∅ ) - {ϵ}_{θ} ( {x}_{t} , ∅ , … , ∅ ) ) + … \\ {γ}^{n} ( {ϵ}_{θ} ( {x}_{t} , {y}_{1} , … , {y}_{n} ) - {ϵ}_{θ} ( {x}_{t} , {y}_{1} , … , {y}_{n - 1} , ∅ ) )\end{matrix}$$

Such a combination may allow such pipelines to apply different weights to different modes of input conditioning. For example, if a user provides a pipeline with an input image to alter, a text description of alterations, and a sample image to be an example of a style related to the alterations, guidance scales (e.g., the γ of the text as compared with the γ of the sample image) may determine how outputs of diffusion models using different conditioning inputs are combined to generate output data. For example, the guidance scales may determine how output data generated using the text as conditioning input is combined with output data generated using the sample image as conditioning input. As an example, if a γ¹ associated with text conditioning inputs is 0.75 and a γ² associated with sample image conditioning inputs is 0.25, when combining outputs generated based on text with outputs based on a sample image, a pipeline may give more weight in the combination to the outputs generated based on the text. Some pipelines may have predetermined guidance scales. For example, a pipeline may have predetermined guidance scales that scale (e.g., weight) text inputs more heavily than sample image inputs.

For combining outputs of diffusion models based on different conditioning inputs, in addition to weighting different conditioning inputs differently, the systems and techniques may weight different conditioning inputs differently dependent on the stage in the iterative diffusion process. For instance, for image-editing-based diffusion models, in early sampling steps (e.g., for stages where t is close to T than to 0) guidance scales are set so that the iterative denoising process relies more on the conditioned image rather than text (to facilitate the fidelity to the source image). In later sampling steps (e.g., for stages where t is closer to 0 than to T) the guidance scales are set to focus on conditioning inputs to focus on the editing.

For example, when combining outputs based on various conditioning inputs at combiner 532, combiner 532 may determine and apply a scaling factor for each output based on the conditioning input and based on stage 500 (e.g., where stage 500 is in the iterative process). For example, combiner 532 may determine and apply a

$${γ}_{t}^{1}$$

to output data 524 and determine and apply a

$${γ}_{t}^{n}$$

to output data 526 when combining output data 522, output data 524, and output data 526 to generate output data 534. For example, such pipelines may combine outputs according to:

$$\begin{matrix}{ϵ}_{θ}^{\sim} ( {x}_{t} ) = {ϵ}_{θ} ( {x}_{t} , ∅ , … , ∅ ) + … \\ {γ}^{1} ( {ϵ}_{θ} ( {x}_{t} , {y}_{1} , … , ∅ ) - {ϵ}_{θ} ( {x}_{t} , ∅ , … , ∅ ) ) + … \\ {γ}^{n} ( {ϵ}_{θ} ( {x}_{t} , {y}_{1} , … , {y}_{n} ) - {ϵ}_{θ} ( {x}_{t} , {y}_{1} , … , {y}_{n - 1} , ∅ ) )\end{matrix}$$

In some aspects, combiner 532 may have a table of scaling factors for various conditioning inputs and steps. For example, combiner 532 may have a table such as:

| | t = 0 | t = 1 | t = 2 | t = 3 | t = 4 | t = 5 | t = 6 | t = 7 | t = 8 |
|---|---|---|---|---|---|---|---|---|---|
| text | 0.6 | 0.55 | 0.55 | 0.5 | 0.5 | 0.45 | 0.45 | 0.4 | 0.4 |
| image | 0.1 | 0.15 | 0.15 | 0.2 | 0.25 | 0.3 | 0.35 | 0.4 | 0.45 |
| audio | 0.3 | 0.3 | 0.3 | 0.3 | 0.25 | 0.25 | 0.2 | 0.2 | 0.15 |

Additionally or alternatively, combiner 532 may determine scaling factors based on one or more equations. For example, for a given conditioning input mode, combiner 532 may determine a scaling factor according to:

$${γ}_{t} = {γ}_{T} + ( T - t ) * δ$$

where δ is specific to the conditioning input mode.

In some aspects, a hyperparameter-search algorithm (e.g., grid search or evolutionary algorithm) may be applied to determine guidance scales (e.g.,

$${γ}_{t}^{1}$$

from t=T to t=0, for a given conditioning-input mode y=1 and

$${γ}_{t}^{2}$$

from t=T to t=0, for a given conditioning-input mode y=2).

For example, stage 500 may obtain as inputs, conditionings (which may be represented as Y={y₁ . . . yₙ}; yᵢ∈R^{d} an indication of a denoising model (e.g., diffusion model 512), and a number of sampling steps, (T). A pipeline as a whole may generate x_{T}˜N(0, I).

For each stage t from T to 1, each stage may determine

$$\{ {γ}_{t}^{1} … {γ}_{t}^{n} \} .$$

Additionally each stage may determine ϵₜ=ϵ_{θ}^{˜}(xₜ) and x₍ₜ₋₁₎ where x₍ₜ₋₁₎=scheduler(xₜ,ϵₜ).

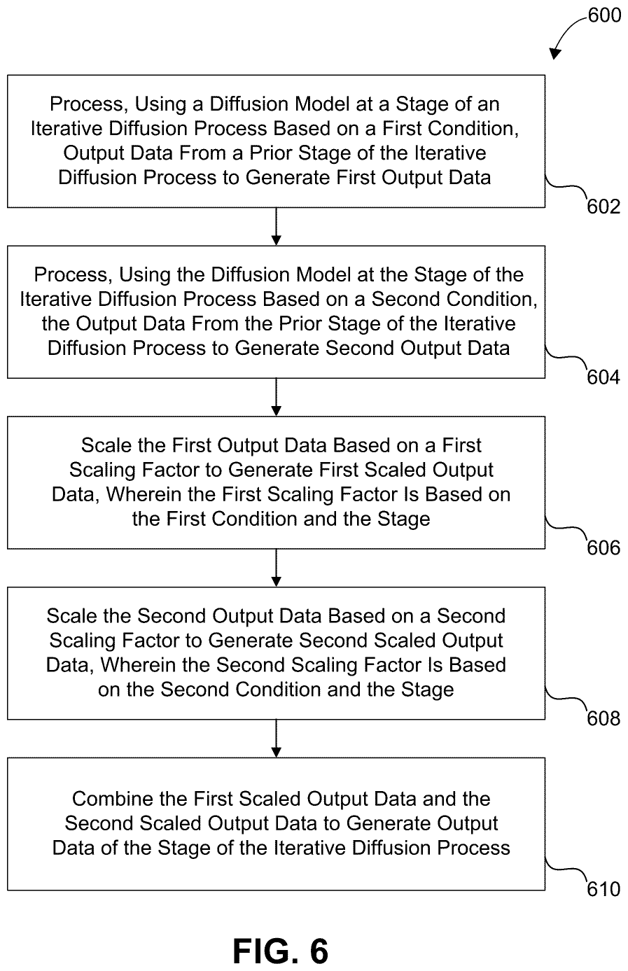

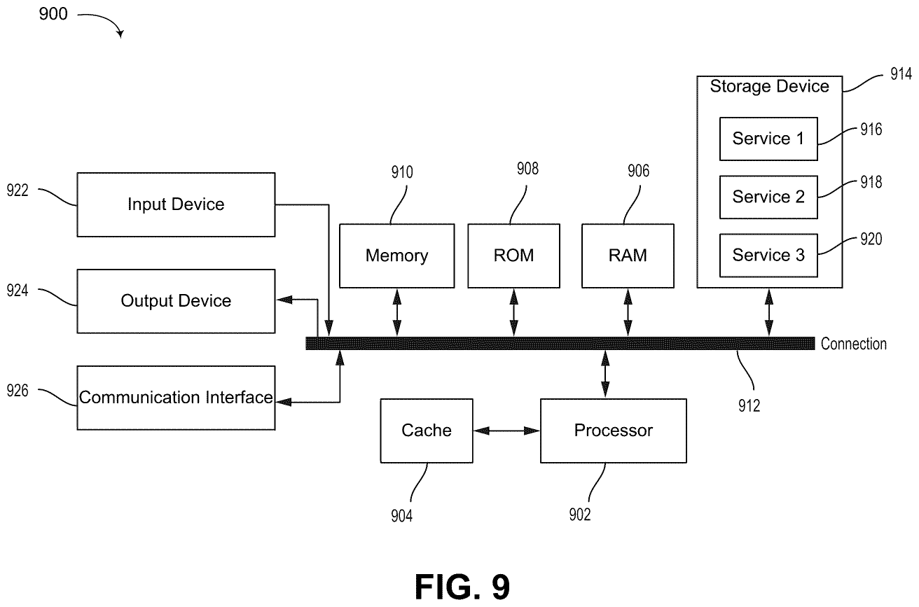

FIG. 6 is a flow diagram illustrating an example process 600 for generating data, in accordance with aspects of the present disclosure. In some examples, the processes described herein (e.g., process 600 and/or other process described herein) may be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the system 100 of FIG. 1 stage 110 of FIG. 1, stage 500 of FIG. 5, the computing-device architecture 900 shown in FIG. 9, and/or other computing device or apparatus.

At block 602, a computing device (or one or more components thereof) may process, using a diffusion model at a stage of an iterative diffusion process based on a first condition, output data from a prior stage of the iterative diffusion process to generate first output data. For example, at stage 500 of an iterative diffusion process, diffusion model 514 may process input data 502 based on conditioning input 504 to generate output data 524. Input data 502 may be an output from a prior stage of the iterative diffusion process.

At block 604, the computing device (or one or more components thereof) may process, using the diffusion model at the stage of the iterative diffusion process based on a second condition, the output data from the prior stage of the iterative diffusion process to generate second output data. For example, at stage 500 of the iterative diffusion process, diffusion model 516 may process input data 502 based on conditioning input 506 to generate output data 526.

At block 606, the computing device (or one or more components thereof) may scale the first output data based on a first scaling factor to generate first scaled output data, wherein the first scaling factor is based on the first condition and the stage. For example, combiner 532 may scale output data 524 by

$${γ}_{n}^{1} .$$

At block 608, the computing device (or one or more components thereof) may scale the second output data based on a second scaling factor to generate second scaled output data, wherein the second scaling factor is based on the second condition and the stage. For example, combiner 532 may scale output data 526 by

$${γ}_{n}^{2} .$$

In some aspects, the first scaling factor may be different from the second scaling factor. For example,

$${γ}_{n}^{1}$$

may be different from

$${γ}_{n}^{2} .$$

In some aspects, the first scaling factor and the second scaling factor may be predetermined. For example,

$${γ}_{n}^{1} and {γ}_{n}^{2}$$

be predetermined.

In some aspects, the first scaling factor and the second scaling factor may be included in a set of scaling factors that are stage-dependent and condition-dependent. For example,

$${γ}_{n}^{1} and {γ}_{n}^{2}$$

may be dependent on a stage (e.g., n). Additionally or alternatively,

$${γ}_{n}^{1} and {γ}_{n}^{2}$$

may be dependent on conditions. For example,

$${γ}_{n}^{1}$$

may be used to scale an output based on conditioning input 504 and

$${γ}_{n}^{2}$$

may be used to scale an output based on conditioning input 506.

In some aspects, the computing device (or one or more components thereof) may select the first scaling factor from among a set of scaling factors based on the first condition and the stage; and select the second scaling factor from among a set of scaling factors based on the second condition and the stage. For example, combiner 532 may select

$${γ}_{n}^{1}$$

from among a set of scaling factors based on conditioning input 504 and select

$${γ}_{n}^{2}$$

from among the set of scaling factors based on conditioning input 506.

In some aspects, the computing device (or one or more components thereof) may determine the first scaling factor based on the first condition and the stage; and determine the second scaling factor based on the second condition and the stage. For example, combiner 532 may determine

$${γ}_{n}^{1}$$

based on conditioning input 504 and determine

$${γ}_{n}^{2}$$

based on conditioning input 506.

In some aspects, the first scaling factor may be determined based on a first scaling-factor equation and the stage; and the second scaling factor is determined based on a second scaling-factor equation and the stage. For example, combiner 532 may determine

$${γ}_{n}^{1}$$

based on a first scaling-factor equation and a stage (e.g., n) and determine

$${γ}_{n}^{2}$$

based on a second scaling-factor equation and a stage (e.g., n).

At block 610, the computing device (or one or more components thereof) may combine the first scaled output data and the second scaled output data to generate output data of the stage of the iterative diffusion process. For example, combiner 532 may combine output data 524 (as scaled) and output data 526 (as scaled) to generate output data 534. Output data 534 may be, or may include, the output of stage 500 of the iterative diffusion process.

In some aspects, the computing device (or one or more components thereof) may use the output data as an input at a subsequent stage of the iterative diffusion process. For example, output data 534 may be used as an input to a subsequent (e.g., subsequent to stage 500) of the iterative diffusion process.

In some aspects, wherein the output data comprises first output data, wherein the at least one processor is configured to: process, using the diffusion model at a subsequent stage of the iterative diffusion process based on the first condition, output data from the stage of the iterative diffusion process to generate third output data; process, using the diffusion model at the subsequent stage of the iterative diffusion process based on the second condition, output data from the stage of the iterative diffusion process to generate fourth output data; scale the third output data based on a third scaling factor to generate third scaled output data, wherein the third scaling factor is based on the first condition and the subsequent stage; scale the fourth output data based on a fourth scaling factor to generate fourth scaled output data, wherein the fourth scaling factor is based on the second condition and the subsequent stage; and combine the third scaled output data and the fourth scaled output data to generate second output data of the subsequent stage of the iterative diffusion process. For example, output data 534 may be used as input data (e.g., in place of input data 502) in a subsequent stage of the iterative diffusion process. For example, diffusion model 514 may process output data 534 based on conditioning input 504 to generate a second instance of output data 524. Further, diffusion model 516 may process output data 534 based on conditioning input 506 to generate a second instance of output data 526. Further, combiner 532 may scale the second instance of output data 524 by

$${γ}_{n + 1}^{1} .$$

Further, combiner 532 may scale the second instance of output data 526 by

$${γ}_{n + 1}^{2} .$$

Further, combiner 532 may combine the second instance of output data 524 (as scaled) and the second instance of output data 526 (as scaled) to generate a second instance of output data 534.

In some aspects, the first scaling factor is different from the third scaling factor. For example,

$${γ}_{n}^{1}$$

may be different from

$${γ}_{n + 1}^{1} .$$

In some aspects, the computing device (or one or more components thereof) may, after a last stage of the iterative diffusion process, at least one of store, display, transmit, or process the output data. For example, output data 120 may be displayed, transmitted, processed, or output.

In some aspects, the computing device (or one or more components thereof) may process the output data from the prior stage of the iterative diffusion process using the diffusion model to generate third output data, wherein the output data is generated further based on the third output data. For example, at stage 500, diffusion model 512 may process input data 502 to generate output data 522. Combiner 532 may scale output data 522 and combine output data 522 (as scaled) with output data 524 (as scaled) and output data 526 (as scaled) to generate output data 534.

In some examples, as noted previously, the methods described herein (e.g., process 600 of FIG. 6, and/or other methods described herein) can be performed, in whole or in part, by a computing device or apparatus. In one example, one or more of the methods can be performed by system 100 of FIG. 1 stage 110 of FIG. 1, stage 500 of FIG. 5, or by another system or device. In another example, one or more of the methods (e.g., process 600, and/or other methods described herein) can be performed, in whole or in part, by the computing-device architecture 900 shown in FIG. 9. For instance, a computing device with the computing-device architecture 900 shown in FIG. 9 can include, or be included in, the components of the system 100, stage 110, and/or stage 500 and can implement the operations of process 600, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 600, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

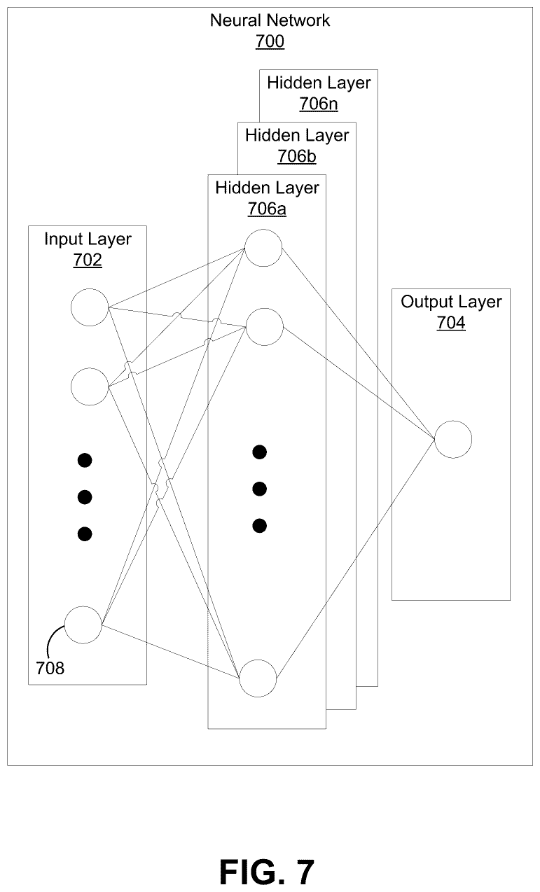

FIG. 7 is an illustrative example of a neural network 700 (e.g., a deep-learning neural network) that can be used to implement machine-learning based data generation, diffusion processing, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 700 may be an example of, or can implement, one or more of the layers of architecture 400 of FIG. 4.

An input layer 702 includes input data. In one illustrative example, input layer 702 can include data representing input data 112 of FIG. 1 and/or an output from prior layer (e.g., output layer 704 of a prior layer of architecture 400). Neural network 700 includes multiple hidden layers, for example, hidden layers 706a, 706b, through 706n. The hidden layers 706a, 706b, through hidden layer 706n include “n” number of hidden layers, where “n” is an integer greater than or equal to one. The number of hidden layers can be made to include as many layers as needed for the given application. Neural network 700 further includes an output layer 704 that provides an output resulting from the processing performed by the hidden layers 706a, 706b, through 706n. In one illustrative example, output layer 704 can provide output data 116 or an input to a subsequent layer (e.g., input layer 702 of a subsequent layer of architecture 400).

Neural network 700 may be, or may include, a multi-layer neural network of interconnected nodes. Each node can represent a piece of information. Information associated with the nodes is shared among the different layers and each layer retains information as information is processed. In some cases, neural network 700 can include a feed-forward network, in which case there are no feedback connections where outputs of the network are fed back into itself. In some cases, neural network 700 can include a recurrent neural network, which can have loops that allow information to be carried across nodes while reading in input.

Information can be exchanged between nodes through node-to-node interconnections between the various layers. Nodes of input layer 702 can activate a set of nodes in the first hidden layer 706a. For example, as shown, each of the input nodes of input layer 702 is connected to each of the nodes of the first hidden layer 706a. The nodes of first hidden layer 706a can transform the information of each input node by applying activation functions to the input node information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 706n can activate one or more nodes of the output layer 704, at which an output is provided. In some cases, while nodes (e.g., node 708) in neural network 700 are shown as having multiple output lines, a node has a single output and all lines shown as being output from a node represent the same output value.

In some cases, each node or interconnection between nodes can have a weight that is a set of parameters derived from the training of neural network 700. Once neural network 700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 700 to be adaptive to inputs and able to learn as more and more data is processed.

Neural network 700 may be pre-trained to process the features from the data in the input layer 702 using the different hidden layers 706a, 706b, through 706n in order to provide the output through the output layer 704. In an example in which neural network 700 is used to identify features in images, neural network 700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 700 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 700 is trained well enough so that the weights of the layers are accurately tuned.

For the example of identifying objects in images, the forward pass can include passing a training image through neural network 700. The weights are initially randomized before neural network 700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 700 can include any other deep network other than a CNN, such as an autoencoder, a deep belief nets (DBNs), a Recurrent Neural Networks (RNNs), among others.

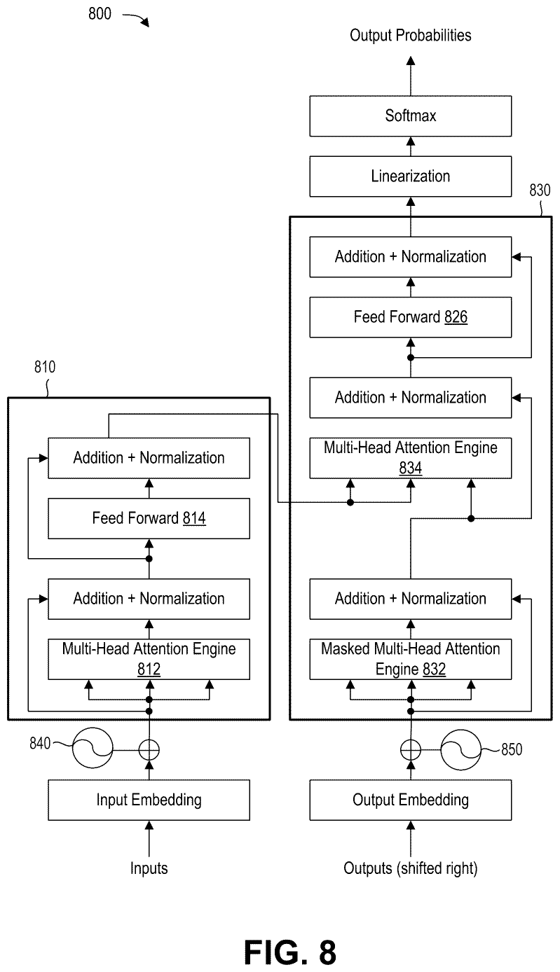

FIG. 8 is a block diagram of an example transformer 800 in accordance with some aspects of the disclosure. In some cases, the transformer 800 may be an example of, or can implement, one or more of the layers of architecture 400 of FIG. 4. In a CNN model, the number of operations required to relate signals from two arbitrary input or output positions grows in the distance between positions, which makes learning dependencies at different distant positions challenging for a CNN model. A transformer 800 reduces the operations of learning dependencies by using an encoder 810 and a decoder 830 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 810 is composed of a stack of six identical layers and each layer has two sub-layers. The first sub-layer is a multi-head self-attention engine 812, and the second sub-layer is a fully connected feed-forward network 814. A residual connection (not shown) connects around each of the sub-layers followed by normalization.

In this example transformer 800, the decoder 830 is also composed of a stack of six 6 identical layers. The decoder also includes a masked multi-head self-attention engine 832, a multi-head attention engine 834 over the output of the encoder 810, and a fully connected feed-forward network 826. Each layer includes a residual connection (not shown) around the layer, which is followed by layer normalization. The masked multi-head self-attention engine 832 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 840 to encode positions because the model does not contain recurrence and convolution and relative or absolute position of the tokens is needed. In the transformer 800, the positional encodings are added to the input embeddings at the bottom layer of the encoder 810 and the decoder 830. The positional encodings are summed with the embeddings because the positional encodings and embeddings have the same dimensions. A corresponding position decoder 850 is configured to decode the positions of the embeddings for the decoder 830.

In some aspects, the transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 800 can process input sequences of variable length, making it well-suited for natural language processing tasks where input lengths can vary greatly. Additionally, the self-attention mechanism allows the transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of system 100 of FIG. 1, stage 110 of FIG. 1, stage 500 of FIG. 5, and/or other devices, modules, or systems described herein. Additionally or alternatively, computing-device architecture 900 may be configured to perform process 600, and/or other process described herein.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating data, the apparatus comprising: at least one memory; and at least one processor coupled to the at least one memory and configured to: process, using a diffusion model at a stage of an iterative diffusion process based on a first condition, output data from a prior stage of the iterative diffusion process to generate first output data; process, using the diffusion model at the stage of the iterative diffusion process based on a second condition, the output data from the prior stage of the iterative diffusion process to generate second output data; scale the first output data based on a first scaling factor to generate first scaled output data, wherein the first scaling factor is based on the first condition and the stage; scale the second output data based on a second scaling factor to generate second scaled output data, wherein the second scaling factor is based on the second condition and the stage; and combine the first scaled output data and the second scaled output data to generate output data of the stage of the iterative diffusion process.

Aspect 2. The apparatus of aspect 1, wherein the at least one processor is configured to use the output data as an input at a subsequent stage of the iterative diffusion process.

Aspect 3. The apparatus of any one of aspects 1 or 2, wherein the output data comprises first output data, wherein the at least one processor is configured to: process, using the diffusion model at a subsequent stage of the iterative diffusion process based on the first condition, output data from the stage of the iterative diffusion process to generate third output data; process, using the diffusion model at the subsequent stage of the iterative diffusion process based on the second condition, output data from the stage of the iterative diffusion process to generate fourth output data; scale the third output data based on a third scaling factor to generate third scaled output data, wherein the third scaling factor is based on the first condition and the subsequent stage; scale the fourth output data based on a fourth scaling factor to generate fourth scaled output data, wherein the fourth scaling factor is based on the second condition and the subsequent stage; and combine the third scaled output data and the fourth scaled output data to generate second output data of the subsequent stage of the iterative diffusion process.

Aspect 4. The apparatus of aspect 3, wherein the first scaling factor is different from the third scaling factor.

Aspect 5. The apparatus of any one of aspects 1 to 4, wherein the at least one processor is configured to, after a last stage of the iterative diffusion process, at least one of store, display, transmit, or process the output data.

Aspect 6. The apparatus of any one of aspects 1 to 5, wherein the first scaling factor is different from the second scaling factor.

Aspect 7. The apparatus of any one of aspects 1 to 6, wherein the first scaling factor and the second scaling factor are predetermined.

Aspect 8. The apparatus of any one of aspects 1 to 7, wherein the first scaling factor and the second scaling factor are included in a set of scaling factors that are stage-dependent and condition-dependent.

Aspect 9. The apparatus of any one of aspects 1 to 8, wherein the at least one processor is configured to: select the first scaling factor from among a set of scaling factors based on the first condition and the stage; and select the second scaling factor from among a set of scaling factors based on the second condition and the stage.

Aspect 10. The apparatus of any one of aspects 1 to 9, wherein the at least one processor is configured to: determine the first scaling factor based on the first condition and the stage; and determine the second scaling factor based on the second condition and the stage.

Aspect 11. The apparatus of aspect 10, wherein: the first scaling factor is determined based on a first scaling-factor equation and the stage; and the second scaling factor is determined based on a second scaling-factor equation and the stage.

Aspect 12. The apparatus of any one of aspects 1 to 11, wherein the at least one processor is configured to process the output data from the prior stage of the iterative diffusion process using the diffusion model to generate third output data, wherein the output data is generated further based on the third output data.

Aspect 13. A method for generating data, the method comprising: processing, using a diffusion model at a stage of an iterative diffusion process based on a first condition, output data from a prior stage of the iterative diffusion process to generate first output data; processing, using the diffusion model at the stage of the iterative diffusion process based on a second condition, the output data from the prior stage of the iterative diffusion process to generate second output data; scaling the first output data based on a first scaling factor to generate first scaled output data, wherein the first scaling factor is based on the first condition and the stage; scaling the second output data based on a second scaling factor to generate second scaled output data, wherein the second scaling factor is based on the second condition and the stage; and combining the first scaled output data and the second scaled output data to generate output data of the stage of the iterative diffusion process.

Aspect 14. The method of aspect 13, further comprising using the output data as an input at a subsequent stage of the iterative diffusion process.

Aspect 15. The method of any one of aspects 13 or 14, wherein the output data comprises first output data, the method further comprising: processing, using the diffusion model at a subsequent stage of the iterative diffusion process based on the first condition, output data from the stage of the iterative diffusion process to generate third output data; processing, using the diffusion model at the subsequent stage of the iterative diffusion process based on the second condition, output data from the stage of the iterative diffusion process to generate fourth output data; scaling the third output data based on a third scaling factor to generate third scaled output data, wherein the third scaling factor is based on the first condition and the subsequent stage; scaling the fourth output data based on a fourth scaling factor to generate fourth scaled output data, wherein the fourth scaling factor is based on the second condition and the subsequent stage; and combining the third scaled output data and the fourth scaled output data to generate second output data of the subsequent stage of the iterative diffusion process.

Aspect 16. The method of aspect 15, wherein the first scaling factor is different from the third scaling factor.

Aspect 17. The method of any one of aspects 13 to 16, further comprising, after a last stage of the iterative diffusion process, at least one of storing, displaying, transmitting, or processing the output data.

Aspect 18. The method of any one of aspects 13 to 17, wherein the first scaling factor is different from the second scaling factor.

Aspect 19. The method of any one of aspects 13 to 18, wherein the first scaling factor and the second scaling factor are predetermined.

Aspect 20. The method of any one of aspects 13 to 19, wherein the first scaling factor and the second scaling factor are included in a set of scaling factors that are stage-dependent and condition-dependent.

Aspect 21. The method of any one of aspects 13 to 20, further comprising: selecting the first scaling factor from among a set of scaling factors based on the first condition and the stage; and selecting the second scaling factor from among a set of scaling factors based on the second condition and the stage.

Aspect 22. The method of any one of aspects 13 to 21, further comprising: determining the first scaling factor based on the first condition and the stage; and determining the second scaling factor based on the second condition and the stage.

Aspect 23. The method of aspect 22, wherein: the first scaling factor is determined based on a first scaling-factor equation and the stage; and the second scaling factor is determined based on a second scaling-factor equation and the stage.

Aspect 24. The method of any one of aspects 13 to 23, further comprising processing the output data from the prior stage of the iterative diffusion process using the diffusion model to generate third output data, wherein the output data is generated further based on the third output data.

Aspect 25. A non-transitory computer-readable storage medium having stored thereon instructions that, when executed by at least one processor, cause the at least one processor to perform operations according to any of aspects 13 to 24.

Aspect 26. An apparatus for providing virtual content for display, the apparatus comprising one or more means for perform operations according to any of aspects 13 to 24.

What is claimed is:

1. An apparatus for generating data, the apparatus comprising:
at least one memory; and
at least one processor coupled to the at least one memory and configured to:
process, using a diffusion model at a stage of an iterative diffusion process based on a first condition, output data from a prior stage of the iterative diffusion process to generate first output data;
process, using the diffusion model at the stage of the iterative diffusion process based on a second condition, the output data from the prior stage of the iterative diffusion process to generate second output data;
scale the first output data based on a first scaling factor to generate first scaled output data, wherein the first scaling factor is based on the first condition and the stage;
scale the second output data based on a second scaling factor to generate second scaled output data, wherein the second scaling factor is based on the second condition and the stage; and
combine the first scaled output data and the second scaled output data to generate output data of the stage of the iterative diffusion process.

2. The apparatus of claim 1, wherein the at least one processor is configured to use the output data as an input at a subsequent stage of the iterative diffusion process.

3. The apparatus of claim 1, wherein the output data comprises first output data, wherein the at least one processor is configured to:
process, using the diffusion model at a subsequent stage of the iterative diffusion process based on the first condition, output data from the stage of the iterative diffusion process to generate third output data;
process, using the diffusion model at the subsequent stage of the iterative diffusion process based on the second condition, output data from the stage of the iterative diffusion process to generate fourth output data;
scale the third output data based on a third scaling factor to generate third scaled output data, wherein the third scaling factor is based on the first condition and the subsequent stage;
scale the fourth output data based on a fourth scaling factor to generate fourth scaled output data, wherein the fourth scaling factor is based on the second condition and the subsequent stage; and
combine the third scaled output data and the fourth scaled output data to generate second output data of the subsequent stage of the iterative diffusion process.

4. The apparatus of claim 3, wherein the first scaling factor is different from the third scaling factor.

5. The apparatus of claim 1, wherein the at least one processor is configured to, after a last stage of the iterative diffusion process, at least one of store, display, transmit, or process the output data.

6. The apparatus of claim 1, wherein the first scaling factor is different from the second scaling factor.

7. The apparatus of claim 1, wherein the first scaling factor and the second scaling factor are predetermined.

8. The apparatus of claim 1, wherein the first scaling factor and the second scaling factor are included in a set of scaling factors that are stage-dependent and condition-dependent.

9. The apparatus of claim 1, wherein the at least one processor is configured to:
select the first scaling factor from among a set of scaling factors based on the first condition and the stage; and
select the second scaling factor from among a set of scaling factors based on the second condition and the stage.

10. The apparatus of claim 1, wherein the at least one processor is configured to:
determine the first scaling factor based on the first condition and the stage; and
determine the second scaling factor based on the second condition and the stage.

11. The apparatus of claim 10, wherein:
the first scaling factor is determined based on a first scaling-factor equation and the stage; and
the second scaling factor is determined based on a second scaling-factor equation and the stage.

12. The apparatus of claim 1, wherein the at least one processor is configured to process the output data from the prior stage of the iterative diffusion process using the diffusion model to generate third output data, wherein the output data is generated further based on the third output data.

13. A method for generating data, the method comprising:
processing, using a diffusion model at a stage of an iterative diffusion process based on a first condition, output data from a prior stage of the iterative diffusion process to generate first output data;
processing, using the diffusion model at the stage of the iterative diffusion process based on a second condition, the output data from the prior stage of the iterative diffusion process to generate second output data;
scaling the first output data based on a first scaling factor to generate first scaled output data, wherein the first scaling factor is based on the first condition and the stage;
scaling the second output data based on a second scaling factor to generate second scaled output data, wherein the second scaling factor is based on the second condition and the stage; and
combining the first scaled output data and the second scaled output data to generate output data of the stage of the iterative diffusion process.

14. The method of claim 13, further comprising using the output data as an input at a subsequent stage of the iterative diffusion process.

15. The method of claim 13, wherein the output data comprises first output data, the method further comprising:
processing, using the diffusion model at a subsequent stage of the iterative diffusion process based on the first condition, output data from the stage of the iterative diffusion process to generate third output data;
processing, using the diffusion model at the subsequent stage of the iterative diffusion process based on the second condition, output data from the stage of the iterative diffusion process to generate fourth output data;
scaling the third output data based on a third scaling factor to generate third scaled output data, wherein the third scaling factor is based on the first condition and the subsequent stage;
scaling the fourth output data based on a fourth scaling factor to generate fourth scaled output data, wherein the fourth scaling factor is based on the second condition and the subsequent stage; and
combining the third scaled output data and the fourth scaled output data to generate second output data of the subsequent stage of the iterative diffusion process.

16. The method of claim 15, wherein the first scaling factor is different from the third scaling factor.

17. The method of claim 13, further comprising, after a last stage of the iterative diffusion process, at least one of storing, displaying, transmitting, or processing the output data.

18. The method of claim 13, wherein the first scaling factor is different from the second scaling factor.

19. The method of claim 13, wherein the first scaling factor and the second scaling factor are predetermined.

20. The method of claim 13, wherein the first scaling factor and the second scaling factor are included in a set of scaling factors that are stage-dependent and condition-dependent.
